(19) United States
(12) Patent Application Publication
(10) Pub. No.: US 2011/0135047 A1
(43) Pub. Date: Jun. 9, 2011

(54) TIME SYNCHRONIZATION IN INDUSTRIAL PROCESS CONTROL OR AUTOMATION SYSTEMS

(75) Inventors: Jean-Charles TOURNIER, Bellegarde sur Valserine (FR); Thomas Werner, Baden (CH)

(73) Assignee: ABB RESEARCH LTD, Zurich (CH)

(21) Appl. No.: 13/019,703

(22) Filed: Feb. 2, 2011

Related U.S. Application Data
(63) Continuation of application No. PCT/EP2009/060861, filed on Aug. 24, 2009.

(30) Foreign Application Priority Data
Aug. 29, 2008 (EP) 08163244.0

(51) Int. Cl. H04L 7/00

(52) U.S. Cl. 375/356

(57) ABSTRACT

Improved time synchronization is provided among the devices of an industrial process control system, e.g., a Substation Automation system, during a temporary absence of a system reference time. Hence, disruption of time-critical protection and control functions due to re-synchronization following the temporary absence of the system reference time is avoided, and the availability of time-critical functions configured on the devices is increased. During normal operation, a device of the system records an offset or discrepancy between the system reference time and an internal local clock of the device for a period of several hours. As soon as the system reference time breaks down, the device starts predicting the offset or drift between its local clock and the unavailable system reference time based on the recorded offset history. As a transient clock master, the device then distributes an approximated or transient system reference time, based on the device's local clock corrected for the predicted offset, to other devices of the system which, in turn, run time-critical protection and control functions.

### RELATED APPLICATIONS

This application claims priority as a continuation application under 35 U.S.C. §120 to PCT/EP2009/060861, which was filed as an International Application on Aug. 24, 2009 designating the U.S., and which claims priority to European Application 08163244.0 filed in Europe on Aug. 29, 2008. The entire contents of these applications are hereby incorporated by reference in their entireties.

### FIELD

The present disclosure relates to the field of time synchronizing a plurality of devices of an industrial process control or automation system. More particularly, the present disclosure relates to time synchronizing a plurality of devices of a Substation Automation (SA) system of a substation of an electric power transmission system.

### BACKGROUND INFORMATION

Substations in high and medium-voltage power networks include primary devices such as electrical cables, lines, bus bars, switches, power transformers and instrument transformers, which are generally arranged in switch yards and/or bays. These primary devices are operated in an automated way via a Substation Automation (SA) system. The SA system includes secondary devices, so-called Intelligent Electronic Devices (IED), which are responsible for protection, control and monitoring of the primary devices. The IEDs may be assigned to hierarchical levels, e.g., the station level, the bay level, and the process level. The process level is separated from the bay level by a so-called process interface. The station level of the SA system includes an Operator Work Station (OWS) with a Human-Machine Interface (HMI) and a gateway to a Network Control Centre (NCC). IEDs on the bay level, also termed bay units, in turn are connected to each other and to the IEDs on the station level via an inter-bay or station bus primarily serving the purpose of exchanging commands and status information. IEDs on the process-level include electronic sensors for voltage (VT), current (CT) and gas density measurements, contact probes for sensing switch and transformer tap changer positions, and/or intelligent actuators (I/O) for controlling switchgear like circuit breakers or disconnectors.

Generally, the internal local clock of a substation IED may present a drift of up to 0.1 ms per sec, while even for a PC with a medium quality clock, a drift of 0.015 ms per sec is normal. However, for the purpose of synchronization with other internal data, sampling of analog signals by an Analog to Digital (A/D) converter of an IED, such as non-conventional current and voltage transformers having a digital output, dedicated merging units, or bay units, require correct time stamping. To this end, the IEDs, as clock clients or slaves, periodically exchange messages with a clock server or master connected to the communication network of the SA system in order to evaluate the relative offset and drift of their local clock. Standard two-way time synchronisation protocols such as IEEE 1588 (IEEE Std 1588-2002, IEEE Standard for a Precision Clock Synchronization Protocol for Networked Measurement and Control Systems) define methods for synchronising devices via a communication network such as a Local Area Network (LAN), to a high precision (better than one microsecond).

From a time synchronization point of view, a known SA system has the following architecture as depicted in FIG. 1. A GPS signal is received by a network device 2, called the grand master clock, inside the SA system. The grand master clock 2 transmits the GPS time using the IEEE 1588 protocol to the devices 10, 20, 30 (mostly IEDs, but also station PCs, gateways, transient fault recorders) connected to the network 1 over TCP/IP.

In the architecture outlined, the GPS signal and its receiving part represent a single point of failure since the loss of the GPS means that the grand master clock will be running on its own local clock which is of lower accuracy than the GPS clock. As an example, the consequences of solar winds, atmospheric disturbances, or thunderstorms hitting the GPS antenna may cause the loss of the correct time. Likewise, temporary islanding, for example, for political, IT security, or maintenance reasons, the SA system by deliberately disconnecting it from a Wide Area Network may cause the grand master clock to run on its own. As a consequence, de-synchronization of geographically distant SA systems may render differential protection functions inoperable.

According to known techniques in the case of a transient failure of the GPS signal, a new master clock, called a transient master, will be elected among the devices and will propagate its own time on the network. Due to environmental conditions (e.g. temperature and pressure) or hardware imperfections (e.g. quartz quality), the transient master clock will drift from the GPS clock. Once the GPS signal comes back and the grand master clock takes over again, an offset will appear between the time sent by the GPS and the one present on the network. This can lead to a situation in which all devices will have to go through a re-synchronization stage. A re-synchronization stage implies an interruption of the control and protection functions running on the devices, as well as an abrupt change of the devices' time base, which in turn may lead to a malfunctioning of the protection algorithms depending on time-tagged data snapshots.

U.S. Pat. No. 4,602,375 is concerned with an on-board satellite clock correction system in which phase errors between the satellite clock and a ground-based clock are determined, and a clock correction value is sent to the satellite. The clock correction value is determined by curve-fitting the determined phase errors in accordance with a polynomial function, updating the polynomial function coefficients so as to minimize any discrepancy between the determined phase errors and those according to the polynomial function, predicting a clock drift in accordance with the polynomial function, and calculating an error correction value in accordance with the predicted clock drift.

U.S. 2001/0021196 discloses a first user transmitting first reference messages with first time base information over a bus (TTCAN) to a second user, and the second user acting as a timer if the information from the first user has not reached the second user before the expiry of a timing mark. The second user may transmit its view of a global time, which is determined based on a presumed constant offset.

U.S. Pat. No. 6,157,957 discloses a clock synchronization method for converting a node local time into a master time base, by exchanging timing information, recording a sequence of timing data, and computing a local-to-master conversion function based on the timing data.

### SUMMARY

An exemplary embodiment provides a method of time synchronizing a plurality of devices of an industrial process control or automation system interconnected through a communication network. A master clock device distributes time synchronization messages including a system reference time over the communication network to slave devices of the industrial process control or automation system. The exemplary method includes: recording, by a device of the system, an offset between the system reference time and a local clock at the device; deriving, by the device, an offset forecast based on the recorded offset; calculating, by the device and upon disruption of the system reference time, a transient system reference time based on the local clock and the derived offset forecast; and distributing, by the device, time synchronization messages including the transient system reference time to other devices of the system. The deriving of the offset forecast includes deriving a first offset forecast according to a first prediction technique for a first disruption duration, and a second offset forecast according to a second prediction technique for a second disruption duration exceeding the first disruption duration.

An exemplary embodiment provides an industrial process control or automation system. The exemplary system includes a communication network, and a plurality of devices. The plurality of devices includes a master clock device and slave devices interconnected through the communication network. The master clock device is configured to distribute time synchronization messages including a system reference time over the communication network to the slave devices. At least one of the devices is configured to: record an offset between the system reference time and a local device clock; derive a first offset forecast and second offset forecast based on a recorded offset and according to a first prediction technique for a first disruption duration, and according to a second prediction technique for a second disruption duration exceeding the first disruption duration, respectively; calculate, upon disruption of the system reference time, a transient system reference time based on the local device clock and the derived offset forecast; and distribute time synchronization messages including the transient system reference time to other devices of the system.

### BRIEF DESCRIPTION OF THE DRAWINGS

Additional refinements, advantages and features of the present disclosure are described in more detail below with reference to exemplary embodiments illustrated in the drawings, in which:

FIG. 1 shows an excerpt of a Substation Automation (SA) system,

FIG. 2 depicts the final offset for three different offset prediction techniques according to an exemplary embodiment of the present disclosure; and

FIG. 3 depicts the corresponding processing times according to an exemplary embodiment of the present disclosure.

The reference symbols used in the drawings, and their meanings, are listed in summary form in the list of reference symbols. In principle, identical parts are provided with the same reference symbols in the figures.

### DETAILED DESCRIPTION

Exemplary embodiments of the present disclosure provide an improved availability of time-critical protection and control functions configured on devices of an industrial process control or automation system. These features are achieved by a method of time synchronizing, and an industrial process control or automation system according to exemplary embodiments as described herein.

According to an exemplary embodiment of the present disclosure, improved time synchronization among the devices of an industrial process control or automation system is provided during a temporary absence of a system reference time. Hence, disruption of time-critical protection and control functions due to re-synchronization following the temporary absence of the system reference time is avoided, and the availability of the time-critical functions configured in/on the devices is increased. During normal operation, a device of the system records or stores (e.g., in an non-transitory computer-readable recording medium) an offset or discrepancy between the system reference time and an internal local clock of the device. As soon as the system reference time breaks down, the device starts predicting the offset or drift between its local clock and the unavailable system reference time based on the recorded offset. As a transient clock master, the device then distributes an approximated or transient system reference time, based on the device's local clock corrected for the predicted offset, to other devices of the system that, in turn, run time-critical protection and control function. According to an exemplary embodiment of the present disclosure, different techniques or algorithms for predicting the offset are implemented. Depending on the length of the disruption period, e.g., the duration of system reference time absence or unavailability, the offset prediction reverts to a first or second offset prediction technique. The method retained for the offset prediction is a trade off between the required and provided accuracy as well as the available processing power and time.

The system reference time can be propagated to the devices of the system by exchanging time synchronization messages between a master clock device and slave devices according to IEEE 1588. The master clock device, in turn, is adapted to receive a Global Positioning System (GPS) signal including a global reference time. Hence, exemplary embodiments of the present disclosure appropriately handle the temporary loss of the GPS signal (e.g., in the case of solar winds or atmospheric disturbances) causing a short disruption of the order of seconds to minutes, the loss of the GPS antenna receiver (e.g. the antenna being hit by a thunderstorm) and the loss of the master clock device (e.g., hardware failure), the latter two requiring human intervention and/or replacement of spare parts on a longer time scale of minutes to hours. Loss of the GPS signal and/or antenna due to exposure to an unfavourable environment and/or long dispatch times for maintenance personnel can be particularly crucial in remotely located substations of an electric power transmission system, for example.

In accordance with an exemplary embodiment of the present disclosure, the disruption duration may be anticipated if the kind of system reference time unavailability (e.g., loss of the GPS signal, antenna, or master clock device) can be determined. However, in case the latter is not possible, and/or in order to avoid unnecessarily precise offset predictions during short disruptions, a transient system reference time is initially determined according to the first technique. In case the disruption still persists after a certain amount of time, the transient system reference time is subsequently determined according to the second technique, which may be computationally more intensive and/or slower in exchange for a more reliable long-term prediction. The first transient master clock device distributing first time synchronization messages based on the first technique may or may not be identical with the second transient master clock device implementing the second prediction technique.

According to an exemplary embodiment, the devices potentially acting as a transient clock master can devote sufficient processing capacity to store an offset history recorded during a period of several hours and compute a drift prediction based there upon. This is certainly true for the master clock device, which, in case of loss of the GPS signal and/or antenna, can itself act as a transient clock master by relying on its local cock. On the other hand, and in order to prepare for the case of a failing master clock device, several if not all of the slave devices that in normal operation rely on the latter, may individually record an offset or drift history and calculate an offset forecast according to a single one or a number of prediction techniques. Out of these devices, one is elected or designated as a transient clock master according to a quality of the local clocks at the slave devices, or according to a kind of the system reference time unavailability.

In accordance with an exemplary embodiment of the present disclosure, the device also records atmospheric quantities such as temperature and/or ambient pressure while recording the offset. With temperature being one of the main factors for quartz deviation, including the recorded temperature information in the evaluation of the offset history, and consulting a temperature forecast in the offset prediction further improves the quality of the transient system reference time.

In short, exemplary embodiments of the present disclosure reduce and ideally avoid the offset between the GPS clock and the time known in a SA system while a GPS signal or the grandmaster clock is not available. The protocol is self-configurable which allows dynamically adding or removing any participating devices (either master or slave) by electing (or designating) the best available clock at runtime. This allows for a smooth re-integration of the GPS clock in the system after a reasonable time frame not exceeding an order of 48 hours. Exemplary embodiments of the present disclosure improve the reliability of the IEEE 1588 protocol without modifying the protocol itself and without requiring each and every Intelligent Electronic Devices (IEDs) of the SA system to participate. Finally, no hardware duplication in view of a fault-tolerant IEEE 1588 implementation or architecture is required either.

In the exemplary embodiments described below, the functions of various devices of the system are described. Each device may include a processor (e.g., a computer processor) configured to perform the operative functions described herein. The processor can execute a computer program containing instructions recorded on a non-transitory computer-readable recording medium (e.g., a ROM, RAM, hard disk drive, optical memory, flash memory, etc.) of the device.

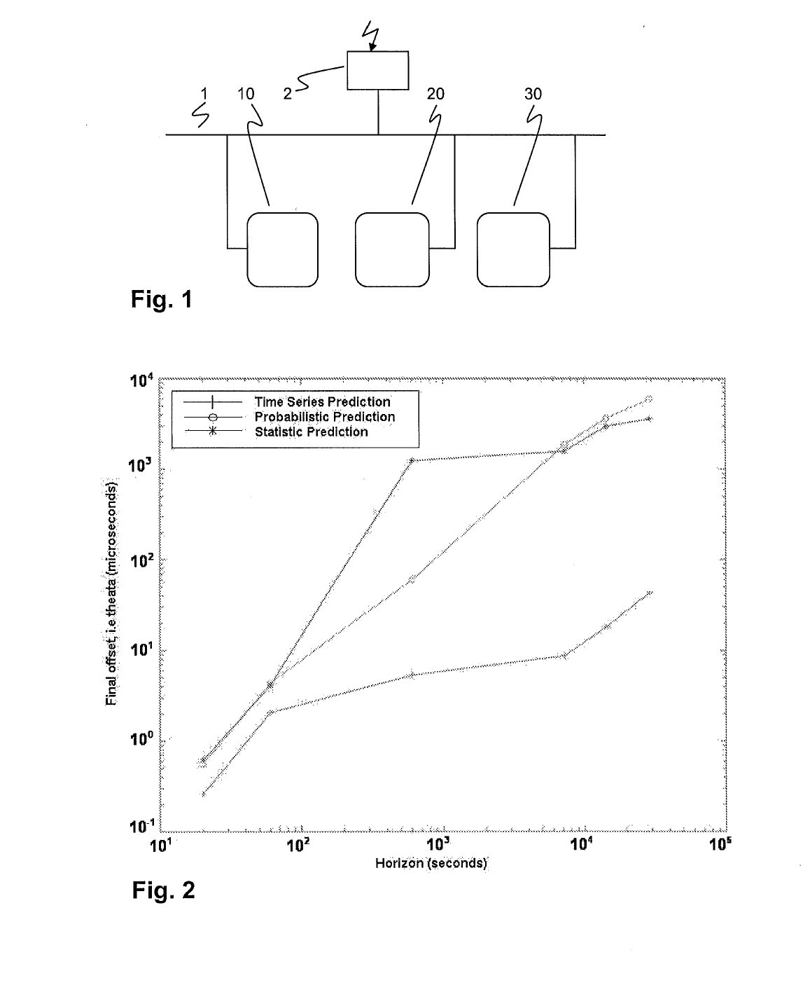

FIG. 1 shows an excerpt of a SA system for a substation of an electric power transmission system as an example of an industrial process control or automation system. The SA system includes a communication network 1, e.g., a station bus or a process bus extending beyond a single bay, and three Intelligent Electronic Devices (IEDs) or bay units 10, 20, 30 as exemplary network devices executing protection and control functions on behalf of a bay of the substation. A master clock device 2 or GPS receiver provides, for example, through Ethernet-based protocols such as IEEE1588, a system reference time to the IEDs and thus assures time synchronization of the protection and control functions configured on the IEDs.

In the context of the present disclosure, two different configurations are considered: (a) the normal configuration where the GPS signal is received and propagated to the SA system; and (b) the faulty configuration, where the GPS signal is missing or the master clock computer is down or disconnected from the communication network. Exemplary embodiments of the present are disclosure are based on an assumption is that the fault is transient, i.e. after a finite time the SA system will be back to the normal configuration. The switchback from a faulty to a normal configuration can occur due to the faulty configuration disappearing (e.g., GPS signal returning), or by a manual service exchanging/repairing the malfunctioning components.

During the normal configuration, one or several of the connected devices including the grand master clock records its offset over several hours or days, for example. Once a new device is elected or designated to function as the transient master in the faulty configuration, the new device performs the normal tasks accomplished by any IEEE 1588 master, including specific distribution of time synchronization messages over the network. However, the transient master, whenever reading its own local time from the device's internal clock, will estimate an offset to the presently unavailable GPS clock and correct the time signal which is distributed to the slaves accordingly.

The offset estimation is based on the offset history and can be performed by way of a statistical approach, either computing an average offset or by identifying patterns out of the history data via a data mining analysis. The pattern is either periodical, e.g., a profile over 24 hours, and/or related to an environmental parameter, e.g., temperature. On the other hand, a probabilistic approach may be used in which the probability of each offset value is evaluated from the data history, and the most probable value is chosen. As with the computation of the statistical average, the prediction is performed only once. As a third and most accurate alternative, a time series prediction involves a model to forecast future events based on known past events. Details about the time series approach can be found in the article “Improving Reliability of IEEE 1588 in Electric Substation Automation” by Jean-Charles Tournier and Xiao Yin, presented at the International IEEE Symposium on Precision Clock Synchronization for Measurement, Control and Communication, IEEE ISPCS 2008, Ann Arbor, Mich., USA, September 2008, the disclosure of which is incorporated herein by way of reference.

FIG. 2 depicts the evolution of the final offset e for each of the three prediction techniques (time series, statistical, probabilistic) as a function of the prediction horizon. The time series based prediction always performs better than the two other ones by a factor of 10 (for a horizon prediction of 20 seconds) to 100 (for a horizon prediction of 28800 seconds).

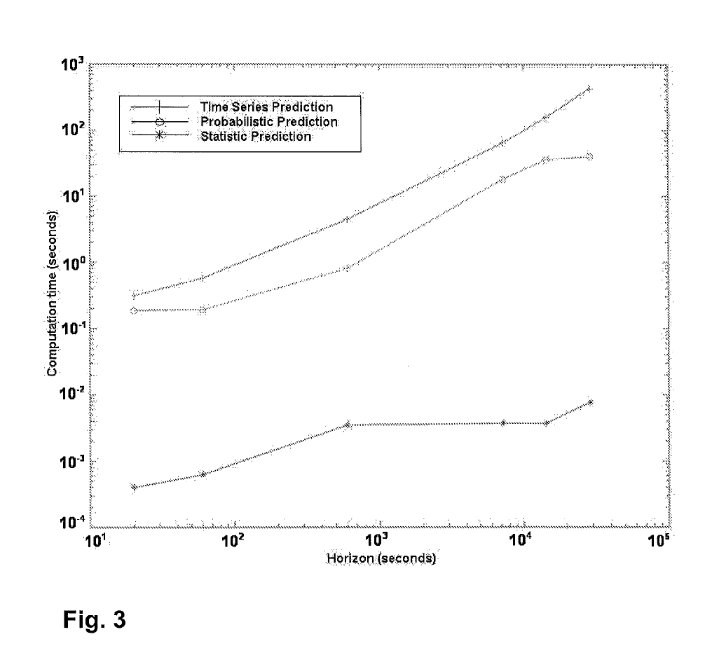

FIG. 3 depicts the evolution of the processing time required for the three prediction techniques (time series, statistical, probabilistic) as a function of the prediction horizon. The processing times reported stem from a specific simulation environment and are indicative of the relative computation requirements for each technique only. The statistical based approach requires low computation compared to the two other approaches. Moreover, this prediction technique is almost not sensitive to the length of the horizon prediction. On the other hand, the time series based approach is computationally intensive and highly influenced by the length of the prediction. The probabilistic based approach has a computing time profile similar to the time series one but with lower values.

From the foregoing results, different prediction techniques are suitable depending on the kind of the GPS disconnection. For example:
In the case of a short disconnection, for example, in the order of a couple of seconds (e.g., atmospheric disturbances), a statistical based approach gives a good enough accuracy (less than 20 μsec) for protection functions at a low computational cost.
On the other hand, in the case of a long disconnection, for example, in the order of a couple of hours (e.g., loss of the GPS antenna or maintenance operations), a time series based prediction is more suitable. However, this kind of prediction cannot be run on any device and has to be supported by a powerful enough computer.
In the case of a medium disconnection, for example, in the order of a couple of minutes, the probabilistic prediction technique is an interesting alternative to the other prediction approaches since the results are still acceptable for some protection functions but at a lower computing price than with the time series based technique.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### List of Designations

1 communication network
2 master clock device
10, 20, 30 network devices

What is claimed is:

1. A method of time synchronizing a plurality of devices of an industrial process control or automation system interconnected through a communication network, wherein a master clock device distributes time synchronization messages including a system reference time over the communication network to slave devices of the industrial process control or automation system, the method comprising:
recording, by a device of the system, an offset between the system reference time and a local clock at the device;
deriving, by the device, an offset forecast based on the recorded offset;
calculating, by the device and upon disruption of the system reference time, a transient system reference time based on the local clock and the derived offset forecast; and
distributing, by the device, time synchronization messages including the transient system reference time to other devices of the system,
wherein the deriving of the offset forecast comprises deriving a first offset forecast according to a first prediction technique for a first disruption duration, and a second offset forecast according to a second prediction technique for a second disruption duration exceeding the first disruption duration.

2. The method according to claim 1, comprising:
distributing, initially, first time synchronization messages based on the first offset forecast; and
distributing, subsequently, second time synchronization messages based on the second offset forecast.

3. The method according to claim 2, comprising:
deriving the second offset forecast only after a first disruption duration has been exceeded.

4. The method according to claim 1, comprising:
recording, by a plurality of slave devices of the system, individual offsets between the system reference time and local clocks at the slave devices; and
selecting a transient clock master from the recording slave devices.

5. The method according to claim 1, comprising:
measuring and recording an atmospheric quantity together with the offset; and
deriving the offset forecast based on a prediction of the atmospheric quantity.

6. The method according to claim 1, wherein the first prediction technique is based on a statistical approach, and the second prediction technique is based on a time series approach.

7. The method according to claim 1, wherein the automation system is a Substation Automation (SA) system of a substation of an electric power transmission system.

8. An industrial process control or automation system comprising:
a communication network;
a plurality of devices including a master clock device and slave devices interconnected through the communication network, wherein the master clock device is configured to distribute time synchronization messages including a system reference time over the communication network to the slave devices, and wherein at least one of the devices is configured to:
record an offset between the system reference time and a local device clock;
derive a first offset forecast and second offset forecast based on a recorded offset and according to a first prediction technique for a first disruption duration, and according to a second prediction technique for a second disruption duration exceeding the first disruption duration, respectively;
calculate, upon disruption of the system reference time, a transient system reference time based on the local device clock and the derived offset forecast; and
distribute time synchronization messages including the transient system reference time to other devices of the system.

9. The method according to claim 3, wherein the first prediction technique is based on a statistical approach, and the second prediction technique is based on a time series approach.

10. The method according to claim 4, wherein the first prediction technique is based on a statistical approach, and the second prediction technique is based on a time series approach.

11. The method according to claim 5, wherein the first prediction technique is based on a statistical approach, and the second prediction technique is based on a time series approach.

12. The system according to claim 8, wherein the first prediction technique is based on a statistical approach, and the second prediction technique is based on a time series approach.

13. The system according to claim 8, wherein the automation system is a Substation Automation (SA) system of a substation of an electric power transmission system.

14. The system according to claim 8, wherein the one of the devices is configured to:
distribute, initially, first time synchronization messages based on the first offset forecast; and
distribute, subsequently, second time synchronization messages based on the second offset forecast.

15. The system according to claim 14, wherein the one of the devices is configured to derive the second offset forecast only after a first disruption duration has been exceeded.
